(19) United States
(12) Patent Application Publication
(10) Pub. No.: US 2018/0274911 A1
(43) Pub. Date: Sep. 27, 2018

(54) METHOD OF INSPECTING A CAST PRODUCT

(71) Applicant: PCC AIRFOILS, INC., Beachwood, OH (US)

(72) Inventor: John C. Filipovich, North Canton, OH (US)

(21) Appl. No.: 15/468,193

(22) Filed: Mar. 24, 2017

(51) Int. Cl. G01B 21/00; F16M 11/22

(52) U.S. Cl. CPC G01B 21/00; F16M 11/22

(57) ABSTRACT

A product inspection method comprises removably mounting the product on a support member and contacting a non-load bearing position indicator with the product. The position indicator includes (i) a first portion with an indicator surface defined with respect to an indicator reference point to contact a product reference surface on the product and (ii) a second portion detectable by a coordinate measuring device. The coordinate measuring device scans the position indicator to determine coordinates of the second portion. The contact reference point's coordinates are calculated based on the second portion's coordinates and a predetermined distance between the indicator reference point and the second portion. The coordinate measuring device scans the product to determine coordinates of a portion of the product's exterior surface based on the calculated coordinates of the indicator reference point. The exterior surface coordinates are compared to coordinates of a corresponding portion of an ideal product's surface.

### FIELD OF THE INVENTION

The present invention relates to a method of inspecting a product and, more particularly, to a method of inspecting a product in which a toad bearing support member supports the weight of the product and a non-toad bearing position indicator in contact with a reference surface on the product is scanned to determine coordinates of a reference point for inspection of the product.

### BACKGROUND OF THE INVENTION

Articles or products, such as turbine blades or airfoils, have been formed by a lost wax investment casting process. The process includes forming a pattern having the configuration of a space or cavity to be formed in a mold in which an article is to be cast. A core portion of the pattern has a configuration corresponding to the configuration of a space to be formed in the article itself.

To form the casting mold pattern, wax is injected into a die cavity around a core. The resulting pattern is subsequently covered with a ceramic mold material. Once the pattern has been covered with a ceramic mold material, the wax portion of the pattern is melted to leave a cavity into which metal is cast. The core is at least partially enclosed by the cast metal. The core is subsequently removed to form space in the cast metal product.

To inspect the cast metal product, the locations of plural points and/or surfaces on the product are determined and compared to as-designed locations of corresponding points and/or surfaces on an as-designed product.

### SUMMARY OF THE INVENTION

The present invention is directed to a method of inspecting a product and, more particularly, to a method of inspecting a product in which a load bearing support member supports the weight of the product and a non-load bearing position indicator in contact with a reference surface on the product is scanned to determine coordinates of a reference point for inspection of the product.

In accordance with an embodiment of the present invention, a method is provided of inspecting a product that has a weight, a longitudinal central axis, and an exterior surface. The method comprises the steps of (a) removably mounting the product on at least one load bearing support member such that substantially all of the weight of the product is supported by the at least one load bearing support member and (b) positioning at least one non-load bearing position indicator in contact with the product such that the at least one non-load bearing position indicator does not support substantially any of the weight of the product. The at least one non-load bearing position indicator includes (i) a first portion with a first indicator surface that contacts a first product reference surface on the product and (ii) at least one second portion detectable by a coordinate measuring device. The first indicator reference surface is defined with respect to a first indicator reference point. The at least one non-load bearing position indicator is configured and dimensioned such that a distance between the first contact reference point and the at least one second portion is predetermined. The method also comprises the step of scanning the at least one position indicator with the coordinate measuring device when the first indicator reference surface is in contact with the first product reference surface such that the at least one second portion of the at least one non-contact load bearing position indicator is detected and such that coordinates of the at least one second portion are determined. The method further comprises the step of calculating coordinates of the first indicator reference point based on the determined coordinates of the least one second portion and the predetermined distance between the first indicator reference point and the at least one second portion. The method still further comprises the step of scanning the product with the coordinate measuring device when the first indicator reference surface is in contact with the first product reference surface such that coordinates of at least a portion of the exterior surface of the product are determined based on the calculated coordinates of the first indicator reference point. The method yet still further comprises the step of comparing (i) the coordinates of said at least a portion of the exterior surface of the scanned product as determined based on the calculated coordinates of the first indicator reference point relative to (ii) coordinates of a corresponding portion of an ideal exterior surface of an ideal product with an ideal first product reference surface.

In accordance with another embodiment of the present invention, a system is provided for inspecting a product. The product has a weight, a longitudinal central axis, and an exterior surface. The system comprises (a) at least one toad bearing support member that when supporting the product supports substantially all of the weight of the product, (b) at least one non-load bearing position indicator that when positioned in contact with the product does not support substantially any of the weight of the product; and (c) a coordinate measuring device. The at least one non-load bearing position indicator includes (i) a first portion with a first indicator reference surface that contacts a first product reference surface on the product and (ii) two laterally spaced apart second portions detectable by the coordinate measuring device. The first indicator reference surface is defined with respect to a first indicator reference point. The at least one non-load bearing position indicator is configured and dimensioned such that a distance between the first indicator reference point and at least one of the two second portions is predetermined. One of said two second portions comprises a first spherical member with a first outer spherical surface. The other of said two second portions comprises a second spherical member with a second outer spherical surface. The non-load bearing position indicator also includes a member with an outer hemi-spherical surface that is laterally spaced apart from both the first spherical member and the second spherical member. The outer hemi-spherical surface is the first indicator reference surface.

In accordance with a further embodiment of the present inventions a non-load bearing position indicator is provided for use in inspecting a product. The product has a weight, a longitudinal central axis, and an exterior surface. The non-load bearing position indicator comprises (i) a first spherical member with a first outer spherical surface detectable by a coordinate measuring device and (ii) a second spherical member with a second outer spherical surface detectable by the coordinate measuring device. The second spherical member is laterally spaced apart from the first spherical member. The non-load bearing position indicator also comprises (ill) a member with a first outer hemi-spherical surface that is laterally spaced apart from the first spherical member and from the second spherical member. The first outer spherical surface is defined with respect to a first center point, the second outer spherical surface is defined with respect to a second center point, and the cuter hemi-spherical surface is defined with respect to a third center point. The first, second, and third center points are aligned in a straight line defining a first axis. The first, second, and third center points are also spaced apart from one another along the first axis. The distance from the first center point along the first axis to the second center point is predetermined, and the distance from the second center point along the first axis to the third center point also is predetermined. The first outer hemispherical surface is an indicator reference surface that contacts a product reference surface on the product. When positioned in contact with the product reference surface, the non-load bearing position indicator does not support substantially any of the weight of the product.

### BRIEF DESCRIPTION OF THE DRAWINGS

The foregoing and other features and advantages of the present invention will become apparent to one skilled in the art upon consideration of the following description of the invention and the accompanying drawings, in which:

FIG. 1 is an elevation view of a product comprising a turbine blade;

FIG. 2 is a second elevation view of the product of FIG. 1 taken from a position orthogonal to the position from which the view of FIG. 1 is taken;

FIG. 3 is a perspective view of the product of FIG. 1 mounted on two spaced apart load bearing support members and positioned in contact with two non-load bearing position indicators in accordance with a first example of the present invention;

FIG. 4 is an elevation view of the product of FIG. 1 positioned in contact with two non-load bearing position indicators;

FIG. 5 is an enlarged view of one of the non-load bearing position indicators of FIG. 4;

FIG. 6 is an elevation view of the product of FIG. 1 positioned in contact with two non-load bearing position indicators, one of which is oriented in a different position relative to the product than the corresponding position indicator shown in FIG. 4;

FIG. 7 is a view of a portion of FIG. 6 to which reference axes and distances have been added;

FIG. 8 is a perspective view of the product of FIG. 1 mounted on a single load bearing support member and positioned in contact with two non-load bearing position indicators in accordance with a second example of the present invention; and

FIG. 9 is a flow chart of a method in accordance with an example of the present invention.

### DETAILED DESCRIPTION

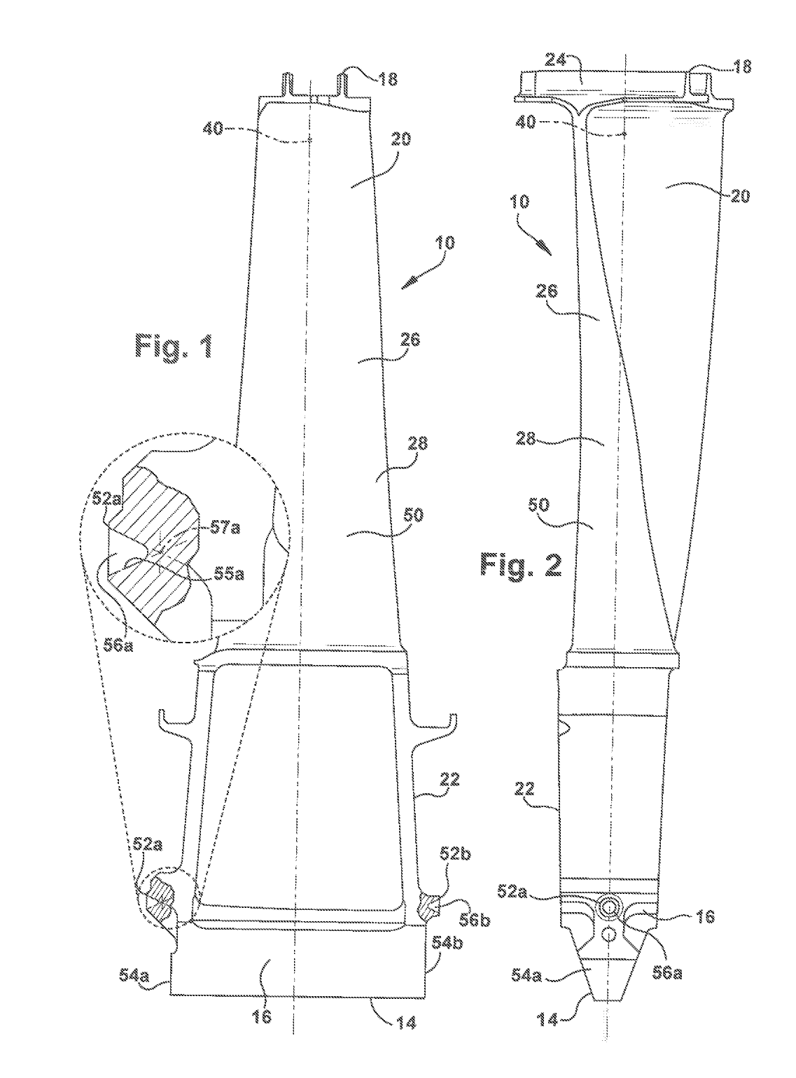

FIGS. 1 and 2 illustrates a high pressure turbine blade 10 for a gas turbine engine or jet engine (not shown), which is a product to be inspected in accordance with an example of the method of the present invention. The illustrated turbine blade 10 is fabricated from metal using an investment casting process and includes an interior cavity or space (not shown). Other products that are similarly fabricated from metal using a lost wax investment casting process and that may be inspected in accordance with an example of the method of the present invention include ether components of a gas turbine engine or jet engine, such as other turbine blades, airfoils, and blade outer air seals. The gas turbine engine may be used, for example, as a propulsion device for a vehicle, such as an airplane, or as a power generating device in a stationary power plant

The turbine blade 10 is cast or otherwise formed in one piece from metal and thus has a weight that is determined by the amount and type of metal from which the turbine blade is formed. The turbine blade 10 has a root end 14, an adjacent root end portion 16, a tip end 18, and an adjacent tip end portion 20. The root end 14 is spaced apart from the tip end 18 by the length of the turbine blade 10. The root end portion 16 includes a first mounting surface 22. The tip end portion 20 includes a second mounting surface 24. The turbine blade 10 also has a longitudinal central axis 40 that extends along the length of the turbine blade from the root end 14 to the tip end 18.

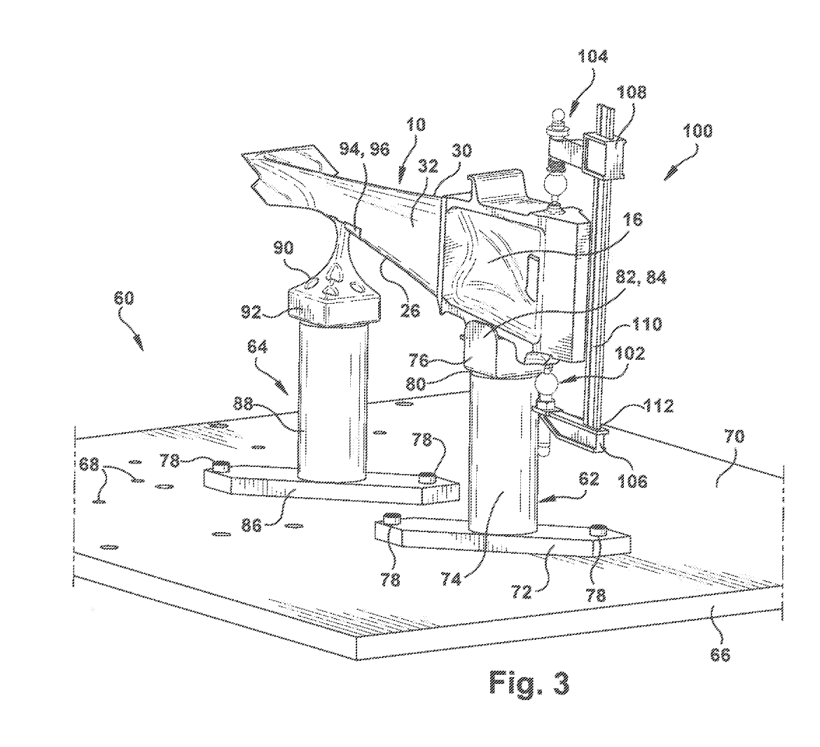

A body portion 26 of the turbine blade 10 extends lengthwise or along the length of the turbine blade from the root end portion 16 to the tip end portion 20. The body portion 26 of the turbine blade 10 includes an airfoil portion 28, which may extend for only part of the length of the body portion. When viewed in cross-section taken perpendicular to the length of the turbine blade 10, as can be seen from FIG. 3, the airfoil portion 28 has an arcuate cross-sectional configuration. The airfoil portion 28 of the turbine blade 10 thus has a convex major side surface 30 and a concave major side surface 32, which is spaced apart from and presented in a direction away from the convex major side surface. The airfoil portion 28 also has a leading edge 34 and a trailing edge 36, as does the tip end portion 20.

The turbine blade 10 is configured with a twist, which relates to the orientation of a chord line or axis defined by the cross-section of the turbine blade relative to an axis that extends generally along the length of the turbine blade. As indicated in FIGS. 1 and 2, the longitudinal central axis 40 extends from the root end 14 of the turbine blade 10 to the tip end 18, which is along the length of the turbine blade 10. More particularly, the longitudinal central axis 40 extends radially outward from an axis of rotation of a gas turbine (not shown) in which the turbine blade 10 is mounted. In successive cross-sections taken along the length of the turbine blade 10 from the root end portion 16 to the tip end portion 20, the arcuate lengths of the convex and concave major side surfaces 30 and 32 of the turbine blade change, and the angular position relative to the longitudinal central axis 40 of the chord line or axis extending between the leading edge 34 and the trailing edge 36 of the turbine blade 10 changes. The turbine blade 10 is also configured with a camber, which relates to the curvature of the camber line 44 or the axis extending along the geometric centerline of the cross-section of the core. If the turbine blade 10 is cast, formed, or produced with too much twist or too little twist as compared to the twist of a theoretical, as-designed or ideal turbine blade or if the turbine blade is cast, formed or produced with too much or too little camber as compared to the twist of a theoretical as-designed or ideal turbine blade, the turbine blade may not function properly when mounted in a gas turbine (not shown).

As cast, formed or produced, the turbine blade 10 has an exterior surface 50 and an internal cavity (not shown). The internal cavity facilitates cooling of the turbine blade when in use. Upon completion of the casting or forming process, the turbine blade 10 requires shaping, metal removal, or machining, which may be performed using computer numerical controlled (“CNC”) equipment. To ensure that the shaping, metal removal, or machining is performed at or on the desired positions or areas of the turbine blade 10 such that all or at least certain critical or specified portions of the exterior surface 50 of the turbine blade after such shaping, metal removal, or machining are located within or fall within acceptable limits as compared to a theoretical, as-designed or ideal turbine blade, one or more reference points or surfaces are established on the turbine blade 10. More specifically, the turbine blade 10 is cast or formed with at least one raised reference portion 52 of the exterior surface 50. As shown, the turbine blade 10 is cast or formed with a first raised reference portion 52a on a first side portion 54a of the root end portion 16 of the turbine blade. The turbine blade 10 is also cast or formed with a second raised reference portion 52b on a second side portion 54b of the root end portion 16 of the turbine blade. The first and second side portions 54a and 54b of the root end portion 16 are disposed opposite each other and are presented in opposite directions.

To provide the desired reference point or reference surface, a conical recess is formed in each of the first and second raised reference portions 52a and 52b by, for example, drilling. A first conical recess 56a is formed in the first raised reference portion 52a. A second conical recess 56b is formed in the second raised reference portion 52b. As shown in the inset on the left side of FIG. 1, the first conical recess 55a has a tapered or conical surface 55a that extends at a constant cone angle from a theoretical tip 57a. Due to limitations on metal shaping techniques and/or equipment, the narrowest part of the first conical recess 56a, which is the portion of the first conical recess farthest to the right. In FIG. 1, may include a rounded, rather than pointed, end to the conical surface 55a, as is shown in FIG. 1. Although only the first conical recess 56a is shown in enlarged detail, the second conical recess 56b has a substantially identical, but mirror-image configuration or shape.

In order to determine whether the first and second conical recesses 56a and 56b have been formed in acceptable positions to permit subsequent shaping, metal removal, or machining of the exterior surface 50 of the turbine blade 10 such that all or at least certain critical or specified portions of the exterior surface 50 after such shaping, metal removal, or machining are located within or fall within acceptable limits as compared to a theoretical, as-designed or idea turbine blade, the turbine blade 10 is inspected using a method in accordance with the present invention. Such a method in accordance with the present invention comprises the step of mounting the turbine blade 10 in a removable or movable or non-permanent manner on a single load bearing support member or, as shown in FIG. 3, plural load bearing support members 62 and 64 such that all or substantially all of the weight of the turbine blade is supported or carried by the load bearing support members. Although two load bearing support members 62 and 64 are shown in FIG. 3, the number of load bearing support members may be greater than two.

The load bearing support members 62 and 64 may be components or parts of a universal fixture assembly 60. The illustrated universal fixture assembly 60 comprises the two load bearing support members 62 and 64 and a mounting plate 66 on which the load bearing support members are mounted. The mounting plate 66 may be a relatively thick sheet or slab of steel or other material capable of carrying or supporting the combined weights of the turbine blade 10 and the load bearing support members 62 and 64. The material of which the mounting plate 66 is made and the thickness of the mounting plate are determined such that the load bearing support members 62 and 64 are substantially immovable relative to one another during or white the turbine blade 10 is being inspected. Multiple openings or bores 68, which may be threaded, are formed in the mounting plate 66 and are distributed in a predetermined pattern on, across or throughout an upper surface 70 of the mounting plate.

The load bearing support member 62 includes an elongated flat plate or foot 72, a cylindrical base 74, and a part specific support 76. The flat plate or foot 72 and the cylindrical base 74 may both be formed of metal and may be permanently connected or joined to one another by, for example, welding. The flat plate or foot 72 may have a hole or passage (not shown) formed adjacent each end of the plate or foot. The flat plate or foot 72 may be mounted on the upper surface 70 of the mounting plate 66 such that each hole (not shown) in the plate or foot is aligned with a different threaded opening or bore 68. A threaded fastener 78 with an enlarged head, such as a bolt, is inserted into each hole or passage (not shown) in the flat plate or foot 72 and screwed into the aligned threaded opening or bore 68 in the mounting plate 66 to hold or maintain the flat plate or foot 72 in place or in position on the upper surface 70 of the mounting plate. The cylindrical base 74 is permanently attached or otherwise secured to a surface of the flat plate or foot 72 opposite the mounting plate 66. The cylindrical base 74 extends away from the flat plate or foot 72 and the mounting plate 66 in a direction perpendicular to the Hat plate or foot and perpendicular to the upper surface 70 of the mounting plate.

The part specific support 76 is mounted on the distal end of the cylindrical base 74, which is the end of the cylindrical base away from the flat plate or foot 72 and the mounting plate 66. One end portion 80 of the part specific support 76 is enlarged to fit closely over the distal end of the cylindrical base 74. An opposite, upper end portion 82 of the part specific support 76 is formed with two spaced apart, upstanding walls 84 (only one of which is shown in FIG. 3). The upstanding walls 84 are configured and dimensioned such that the root end portion 16 of the turbine blade 10 will fit closely between the upstanding walls. The pad specific support 76 may be formed or made from metal or plastic or any other material that will be strong and rigid enough to carry or support the weight of the turbine blade 10 substantially without deflecting or moving during inspection of the turbine blade.

Like the load bearing support member 62, the load bearing support member 64 includes an elongated flat plate or foot 86, a cylindrical base 88, and a part specific support 90. The flat plate or foot 86 and the cylindrical base 88 may both be formed of metal and may be permanently connected or joined to one another by, for example, welding. The flat plate or foot 86 may have a hole or passage (not shown) formed adjacent each end of the plate or foot. The flat plate or foot 86 may be mounted on the upper surface 70 of the mounting plate 66 such that each hole (not shown) in the plate or foot is aligned with a different threaded opening or bore 68. A threaded fastener 78 with an enlarged head, such as a bolt, is inserted into each hole or passage (not shown) in the flat plate or foot 86 and screwed into the aligned threaded opening or bore 68 in the mounting plate 66 to hold or maintain the flat plate or foot 86 in place or in position on the upper surface 70 of the mounting plate. The cylindrical base 88 is permanently attached or otherwise secured to a surface of the flat plate or foot 86 opposite the mounting plate 66. The cylindrical base 88 extends away from the flat plate or feet 72 and the mounting plate 66 in a direction perpendicular to the flat plate or foot and perpendicular to the upper surface 70 of the mounting plate.

The part specific support 90 is mounted on the distal end of the cylindrical base 88, which is the end of the cylindrical base away from the flat plate or foot 86 and the mounting plate 66. One end portion 92 of the part specific support 90 is enlarged to fit closely over the distal end of the cylindrical base 88. An opposite, upper end portion 94 of the part specific support 90 is formed with two spaced apart, upstanding walls 96 (only one of which is shown in FIG. 3). The upstanding walls 96 are configured and dimensioned such that the body portion 26 of the turbine blade 10 will fit closely between the upstanding walls. The part specific support 90 may be formed or made from metal or plastic or any other material that will be strong and rigid enough to carry or support the weight of the turbine blade 10 substantially without substantially deflecting or moving during inspection of the turbine blade.

The inspection method in accordance with the present invention also comprises the step of positioning a single non-load bearing position indicator or, as shown in FIG. 3, plural non-load bearing position indicators 102 and 104 in contact with the turbine blade 10 in a removable or movable or non-permanent manner such that the non-load bearing position indicators do not support or carry any or substantially any of the weight of the turbine blade 10. As used in this application, the word “substantially” means that, to the extent commercially practical, a particular outcome or result will be achieved. Thus, a statement that a non-load bearing position indicator does not support or carry “substantially any” of the weight of a second member or device, such as the turbine blade 10, means that, to the extent commercially practical, the non-load bearing position indicator is not intentionally positioned in contact with the second member or device so as to support or carry any of the weight of the second member or device. Although two non-load bearing position indicators 102 and 104 are shown in FIG. 3, the number of non-load bearing position indicators may be greater than two.

The non-load bearing position indicators 102 and 104 may be components or parts of a position indicator assembly 100. The illustrated position indicator assembly 100 comprises the two non-load bearing position indicators 102 and 104, two laterally extending support brackets 106 and 108, and a vertically extending mounting rod 110. The non-load bearing position indicator 102 is mounted on or carried by the support bracket 106. The support bracket 106, in turn, is mounted on or carried by the mounting rod 110. The mounting rod 110, as shown, is suspended from an overhead support (not shown). The support bracket 106 and thus the non-load bearing position indicator 102 are disposed or positioned on a tower end portion 112 of the mounting rod, which thus means the support bracket 106 and the non-load bearing position indicator 102 may be disposed or positioned at or closely adjacent to the lower end of the mounting rod 110. Similarly, the non-load bearing position indicator 104 is mounted on or carried by the support bracket 108. The support bracket 108, in turn, is mounted on or carried by the mounting rod 110. The support bracket 108 is mounted on the mounting rod 110 at a location that is above and spaced apart from the support bracket 106 by at least the distance between the first and second side portions 54a and 54b of the root end portion 16 of the turbine blade 10.

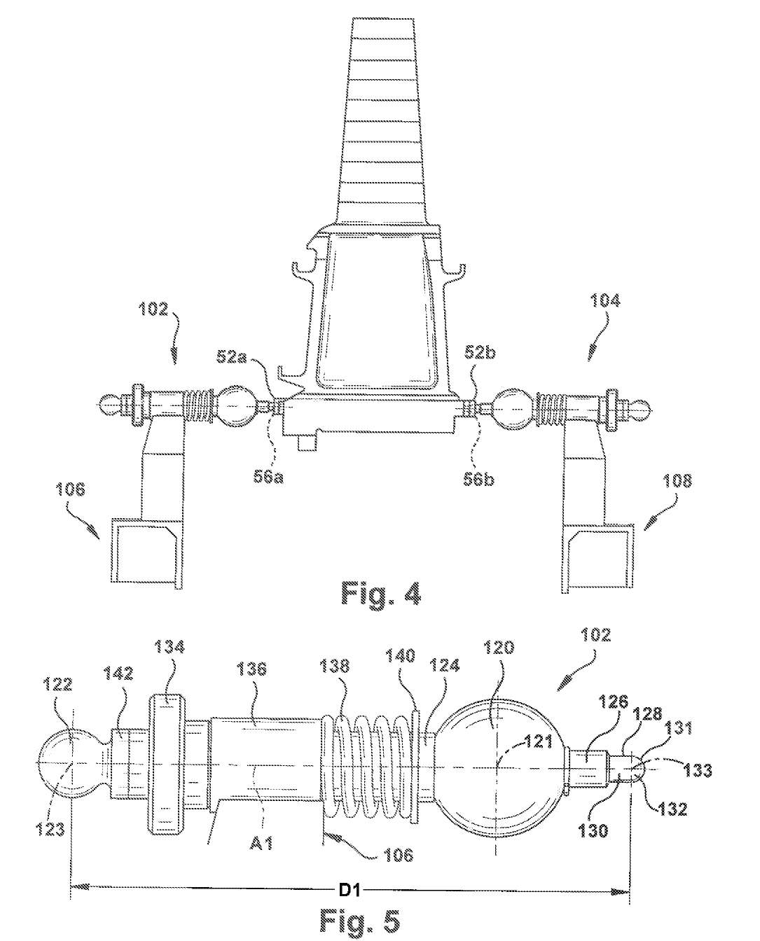

As best shown in FIGS. 4 and 5, the non-load bearing position indicator 102 may be identical to the non-load bearing position indicator 104, and the support bracket 106 may be identical to the support bracket 108. The non-load bearing position indicator 104 and the support bracket 108 are mounted in orientations that are mirror images of the orientations of the non-load bearing position indicator 102 and the support bracket 106, respectively. Accordingly, the details of the non-load bearing position indicators 102 and 104 and the interaction between the non-load bearing position indicators and the corresponding support brackets 106 and 108 will be described with reference to the non-load bearing position indicator 102 and its corresponding support bracket 106, as shown in FIG. 5.

The non-load bearing position indicator 102 comprises a relatively larger diameter spherical member 120 with an outer spherical surface and a relatively smaller spherical member 122 with an outer spherical surface. The relatively larger spherical member 120 and its outer spherical surface are defined with respect to a center point or center 121. Specifically, the center point or center 121 of the spherical member 120 is the central point from which all points on the outer surface of the spherical member 120 are equidistant or at a fixed radius. Similarly, the relatively smaller spherical member 122 and its outer spherical surface are defined with respect to a center point or center 123. Like the center 121 of the spherical member 120, the center point or center 123 of the spherical member 122 is the central point from which all points on the outer surface of the spherical member 122 are equidistant or at a fixed radius. The spherical member 120 is securely and permanently joined or fixed to the spherical member 122 by an elongated shaft 124, which extends between and separates the spherical members 120 and 122. The spherical members 120 and 122 and the shaft 124 may be formed in one piece or, more typically, may be formed separately and subsequently permanently joined or fixed together. The distance from the center 121 of the spherical member 120 along the shaft 124 to the center 123 of the spherical member 122 is predetermined and precisely measured.

A hollow stub shaft 126 projects away from the larger spherical member 120 at a location that is diametrically opposite a point at which the spherical member 120 is joined to the shaft 124. The hollow stub shaft 126 receives one end of a cone locator 123 that includes a short solid shaft 130 and a hemi-spherical tip 132. The solid shaft 130 is received in the open end of the hollow stub shaft 126, and the hemi-spherical tip 132 projects from the hollow stub shaft. When the cone locator 128 is fully seated in the hollow stub shaft 126 and thus cannot move into the hollow stub shaft farther to the left, as viewed in FIG. 5, the cone locator is fixed in place in the hollow stub shaft. The distance D1 from the center 123 of the spherical member 122 along the shaft 124 and the stub shaft 126 to the center 133 of the hemi-spherical tip 132 is thereby predetermined and is precisely measured. The center 133 of the hemi-spherical tip 132 is the central point from which all points on the outer surface 131 of the hemi-spherical tip are equidistant. Stated differently, the center 133 of the hemi-spherical tip 132 is the center of a sphere that includes the outer surface 131 of the hemi-spherical tip 132

Between the relatively larger spherical member 120 and the relatively smaller spherical member 122 are an annular spacer nut 134, a sleeve portion 136 of the support bracket 106, a spring member 138, and an annular spring stop 140. The sleeve portion 136 of the support bracket 106 encircles the shaft 124 such that the sleeve portion and the support bracket can move or slide axially relative to the shaft 124. The annular spacer nut 134 is disposed or located between the spherical member 122 and the sleeve portion 136 of the support bracket 106. Like the sleeve portion 136, the annular spacer nut 134 encircles the shaft 124. The annular spacer nut 134 has an internal threaded surface (net shown) that engages an external threaded surface (not shown) of the shaft 124. The annular spacer nut 134 may thus be twisted with an appropriate tool (not shown) to adjust the position of the annular spacer nut along the length of the shaft 124 and thereby to apply or modify a pre-load applied to the spring member 138. Movement of the annular spacer nut 134 along the shaft 124 toward the spherical member 122 is limited by a collar portion 142 of the shaft 124. The collar portion 142 is formed in one piece with or formed separately from and then permanently joined or fixed to the shaft 124 and projects radially outward from the remainder of the shaft 124.

The spring member 138 is disposed or located between the relatively larger spherical member 120 and the sleeve portion 136 of the support bracket 106. Like the sleeve portion 136, the spring member 138, which is a coil spring, encircles the shaft 124 and can move or slide axially relative to the shaft 124. Movement of the spring member 138 along the shaft 124 toward the spherical member 120 is limited by the annular spring stop 140. The annular spring stop 140 is formed separately from the shaft 124, but is immovable joined or fixed to the shaft 124. The annular spring stop 140 may, for example, be a snap ring that fits into and engages a circumferential groove (not shown) formed in an external surface of the shaft 124. The annular spring stop 140 projects radially outward from the shaft 124.

When the non-load bearing position indicator 102 is fully assembled and mounted on the support bracket 106, the non-load bearing position indicator and the support bracket can move relative to one another along an axis A1. The axis A1 extends in a straight line through the center 121 of the relatively larger spherical member 120, the center 123 of the relatively smaller spherical member 122, and the center 133 of the hemi-spherical tip 132. The maximum extent of the relative axial movement between the non-load bearing position indicator 102 and the support bracket 106 is determined by the distance between the annular spacer nut 134 and the annular spring stop 140, together with the width of the sleeve portion 136 of the support bracket 106 along the shaft 124. In addition, the spring member 138 pushes against the annular spring stop 140 and the sleeve portion 136 of the support bracket 106 and thus tends to force, push or resiliency bias the annular spring stop and the sleeve portion away from one another. Consequently, when the support bracket 106 is mounted in a particular position on the mounting rod 110, the spring member 138 will push or resiliency bias the non-load bearing position indicator 102 and, more specifically, the hemi-spherical tip 132 of the non-load bearing position indicator to the right, as viewed in FIG. 5.

By mounting the support bracket 106 in a first position on the mounting rod 110 and mounting the support bracket 108 in a second position on the mounting rod spaced apart from the first position, and further by mounting the non-load bearing position indicators 102 and 104 such that their respective hemi-spherical tips 132 are presented toward one another, the non-load bearing position indicators 102 and 104 will be arranged, located or positioned to contact the first conical recess 56a and the second conical recess 56b, respectively, of the exterior surface 50 of the turbine blade 10, as shown in FIG. 4. As will be appreciated, the hemi-spherical tips 132 of the non-load bearing position indicators 102 and 104 will be positioned within the first and second conical recesses 56a and 56b.

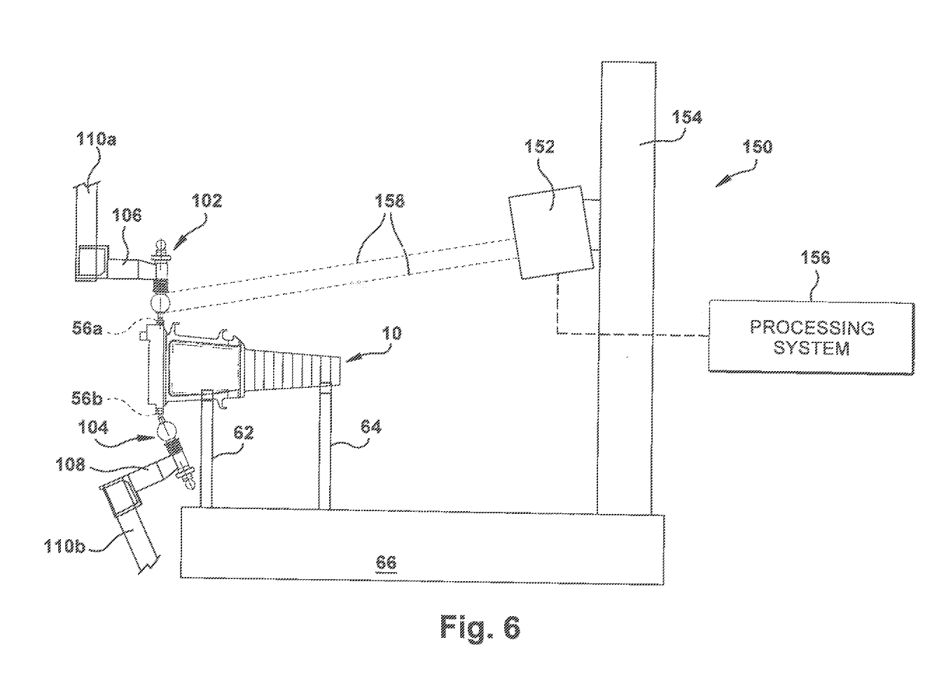

After the turbine blade 10 has been supported on the load bearing support members 62 and 64 and after the non-load bearing position indicators 102 and 104 have been positioned in contact with the first and second conical recesses 56a and 56b of the turbine blade 10, the next step in the inspection method in accordance with the present invention is to scan the non-load bearing position indicators with a coordinate measuring device such that either one or both of the spherical members 120 and 122 is detected by the coordinate measuring device and such that coordinates of either one or both of the spherical members 120 and 122 are determined. This step in the process is illustrated schematically in FIG. 6.

In FIG. 6, the arrangement of the non-load bearing position indicators 102 and 104 varies somewhat from the arrangement of the non-load bearing position indicators shown in FIGS. 3 and 4. In particular, rather than both of the support brackets 106 and 108 being mounted on a single, vertically extending mounting rod 110, as shown in FIG. 3, the support brackets are mounted on two separate mounting rods 110a and 110b. The mounting rods 110a and 110b are not axially aligned, but rather are oriented at an angle relative to one another. Consequently, the non-load bearing position indicators 102 and 104 also are not aligned axially with one another, but rather are oriented at an angle relative to one another. At the same time, the respective hemispherical tips 132 of the non-load bearing position indicators 102 and 104 are still presented toward one another, and the non-load bearing position indicators 102 and 104 are still arranged, located or positioned to contact the first conical recess 56a and the second conical recess 56b, respectively, of the exterior surface 50 of the turbine blade 10, as shown in FIG. 6. As with the arrangement of FIG. 3, the turbine blade 10 is mounted in a removable or movable or non-permanent manner on load bearing support members 62 and 64 such that all or substantially all of the weight of the turbine blade is supported or carried by the load bearing support members.

To assess, evaluate or determine whether the first and second conical recesses 56a and 56b have been formed in acceptable positions to permit subsequent shaping, metal removal, or machining of the exterior surface 50 of the turbine blade 10 such that all or at least certain critical or specified portions of the exterior surface 50 after such shaping, metal removal, or machining are located within or fall within acceptable limits as compared to a theoretical, as-designed, or ideal turbine blade, the coordinates in space of the first and second conical recesses 56a and 56b may be determined. Alternatively, because the first and second conical recesses 56a and 56b are relatively small indentations or depressions in the exterior surface 50 of the turbine blade 10, it may be more practical to determine the coordinates in space of a proxy surface or proxy reference point. The method of the present invention involves determining the coordinates in space of at least a portion of each of the non-load bearing position indicators 102 and 104 and then calculating or determining the coordinates in space of the centers 133 of the hemi-spherical tips 132 of the non-load bearing position indicators 102 and 104. The coordinates in space of the centers 133 are then used as proxy reference points for the coordinates in space of the first and second conical recesses 56a and 56b.

More particularly, a first portion of each of the non-load bearing position indicators 102 and 104, namely, the corresponding hemispherical tip 132, is positioned in contact with a portion of the exterior surface 50 of the turbine blade 10 within the first and second conical recesses 56a and 56b, such as the conical surface 56a. A second portion of each of the non-load bearing position indicators 102 and 104, namely, one or both of the spherical members 120 and 122, is exposed outside of the first and second conical recesses 56a and 56b such that the second portion can be detected by a coordinate measuring device and its coordinates in space can be determined by the coordinate measuring device. If outer spherical surfaces of both of the spherical members 120 and 122 of each non-load bearing position indicator 102 and 104, and thus the spherical members, are detected by the coordinate measuring device, the coordinates in space of the centers 121 and 123 of the outer spherical surfaces and the spherical members can be calculated or determined. An imaginary or virtual line extending through and connecting the centers 121 and 123 of the two spherical members 120 and 122 will provide the axis A1 through both centers, which can be extended to include the center 133 of the hemi-spherical tip 132. Based on the coordinates in space of the centers 121 and 123 of the two spherical members 120 and 122, a direction or azimuth of the axis A1 can be calculated. The coordinates of the center 133 of the hemi-spherical tip 132 can then be calculated from the direction or azimuth and the known, predetermined distance D1 from the center of the hemi-spherical tip to the center 123 of the spherical member 122 or a corresponding predetermined distance to the center 121 of the spherical member 120.

FIG. 6 illustrates schematically a system 150 with which the process of the present invention can be implemented. The system 150 includes the two mounting rods 110a and 110b, the two support brackets 106 and 108, the two non-load bearing position indicators 102 and 104, the two load bearing support members 62 and 64, the mounting plate 66, a coordinate measuring device 152, a support 154 for the coordinate measuring device, and a processing system 156 associated with and electrically connected to the coordinate measuring device. As shown, the coordinate measuring device 152 is a laser-based device, which projects one or more beams 158 of laser light with which to scan the turbine blade 10 and the non-load bearing position indicators 102 and 104. The coordinate measuring device 152 may, however, be a blue light-based device or an infrared-based device or a mechanical probe-based device. The processing system 156 may be included within the coordinate measuring device 152 and may include one or more controllers or processors for controlling or operating the scanning function of the coordinate measuring device and for determining or calculating the coordinates of the second portions or spherical members 120 and 122 of the non-load bearing position indicators 102 and 104, as well as making other determinations or calculations of the method of the present invention.

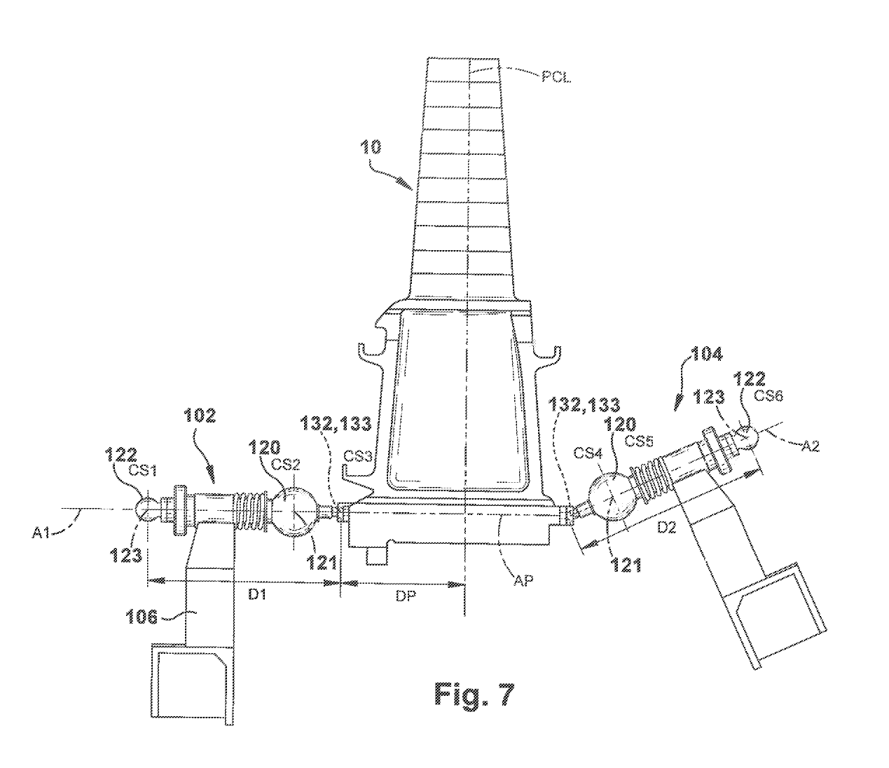

FIG. 7 is an enlarged illustration of the non-load bearing position indicators 102 and 104 and the turbine blade 10 shown in FIG. 6, on which notations relevant to the coordinate determinations or calculations have been indicated. In particular, the non-load bearing position indicator 102 is shown with its spherical member 122 (also labeled CS1), its spherical member 120 (also labeled CS2), and its hemi-spherical tip 132 (also labeled CS3). Similarly, the non-load bearing position indicator 104 is shown with its spherical member 122 (also labeled CS6), its spherical member 120 (also labeled CS5), and its hemi-spherical tip 132 (also labeled CS4).

Extending from the center 123 of spherical member CS1 to the center 121 of spherical member CS2 is the axis A1. Extension of the axis A1 beyond the center 121 of spherical member CS2 causes the axis to pass through the center 133 of the hemi-spherical tip 132 or hemi-spherical member CS3. The distance D1 from the center 123 of spherical member CS1 to the center 133 of the hemi-spherical tip 132 or hemispherical member CS3 is known and predetermined during the construction, fabrication, or assembly of non-load bearing position indicator 102.

Similarly, extending from the center 123 of spherical member CS6 to the center 121 of spherical member CS5 is an axis A2. Extension of the axis A2 beyond the center 121 of spherical member CS4 causes the axis to pass through the center 133 of the hemi-spherical tip 132 or hemi-spherical member CS4. The distance D2 from the center 123 of spherical member CS6 to the center 133 of the hemi-spherical tip 132 or hemi-spherical member CS4 is known and predetermined during the construction, fabrication, or assembly of non-load bearing position indicator 104.

As can be seen, the non-load bearing position indicator 102 may be regarded as a first non-load bearing position indicator that includes a first spherical member 122 (also labeled CS1), a second spherical member 120 (also labeled CS2), and a first member with a first hemi-spherical tip 132 (also labeled CS3). Likewise, the non-load bearing position indicator 104 may be regarded as a second non-load bearing position indicator that includes a third spherical member 122 (also labeled CS6), a fourth spherical member 120 (also labeled CS5), and a second member with a second hemi-spherical tip 132 (also labeled CS4). The outer hemi-spherical surface of the first hemi-spherical tip 132 is thus effectively a first indicator reference surface when placed in contact with the conical surface 55a of the first conical recess 56a, which is effectively a first product reference surface. The outer hemi-spherical surface of the second hemi-spherical tip 132 is similarly effectively a second indicator reference surface when placed in contact with the conical surface of the second conical recess 56b, which is effectively a second product reference surface.

The coordinates in space of the center 133 of the first hemi-spherical tip 132 or hemi-spherical member CS3 may be calculated by the processing system 156 based on the coordinates in space of the center 123 of spherical member CS1, the direction or azimuth of axis A1, and the distance D1. Likewise, the coordinates in space of the center 133 of the second hemispherical tip 132 or hemispherical member CS4 may be calculated by the processing system 156 based on the coordinates in space of the center 123 of spherical member CS6, the direction or azimuth of axis A2, and the distance D2. Based on the coordinates in space of the centers 133 of the hemispherical members CS3 and CS4, a length and a direction or azimuth of a part axis or product axis AP extending from one of those two centers to the other of those two centers may be calculated or determined by the processing system 156. The processing system 156 may then use a theoretical, as-designed, or ideal distance DP from the center of the sphere defined by hemispherical member CS3 along the product axis AP to calculate the coordinates of an intersection between the product axis AP and a central, longitudinal centerline PCL of a theoretical, as-designed, or ideal turbine blade corresponding to the turbine blade 10.

With the calculated coordinates of the intersection between the product axis AP and the central, longitudinal centerline PCL and a theoretical, as-designed, or ideal direction or azimuth of the central, longitudinal centerline of a theoretical, ideal, or as-designed turbine blade, the processing system 156 now has the essential elements of a part-specific, central longitudinal centerline PCL from which the contours of the exterior surface 50 of the turbine blade 10 may be measured to ensure that all or at least certain critical or specified portions of the exterior surface 50 of the turbine blade are located within or fall within acceptable limits as compared to a theoretical, as-designed, or ideal exterior surface of a theoretical, as-designed, or ideal turbine blade.

It will be appreciated from the foregoing description that the coordinates in space of the centers 133 of the hemi-spherical tips 132 of the non-load bearing position indicators 102 and 104 are being used as proxy reference points for the conical surface 55a and/or theoretical tip 57a of the first conical recess 56a and the corresponding conical surface and/or theoretical tip of the second conical recess 56b. To provide the desired accuracy of subsequent calculations, determinations, and product inspection, the conical surface 55a of the first conical recess 56a and the corresponding conical surface of the second conical recess 56b must be machined or otherwise formed to a known, predetermined cone angle within relatively close or tight manufacturing tolerances. Likewise, the outer surfaces 131 of the hemispherical tips 132 of the non-load bearing position indicators 102 and 104 must be machined or otherwise formed to a known, predetermined hemi-spherical shape having a predetermined spherical radius within relatively close or tight manufacturing tolerances. Only with sufficient accuracy in machining or other forming will the contact line between the first conical surface 55a and the outer surface 131 of the corresponding hemispherical tip 132, as well as the contact line between the second conical surface and the outer surface 131 of the corresponding hemi-spherical tip 132, be positioned sufficiently accurately for dependable and accurate use of the proxy reference points in subsequent calculations, determinations, and product inspection.

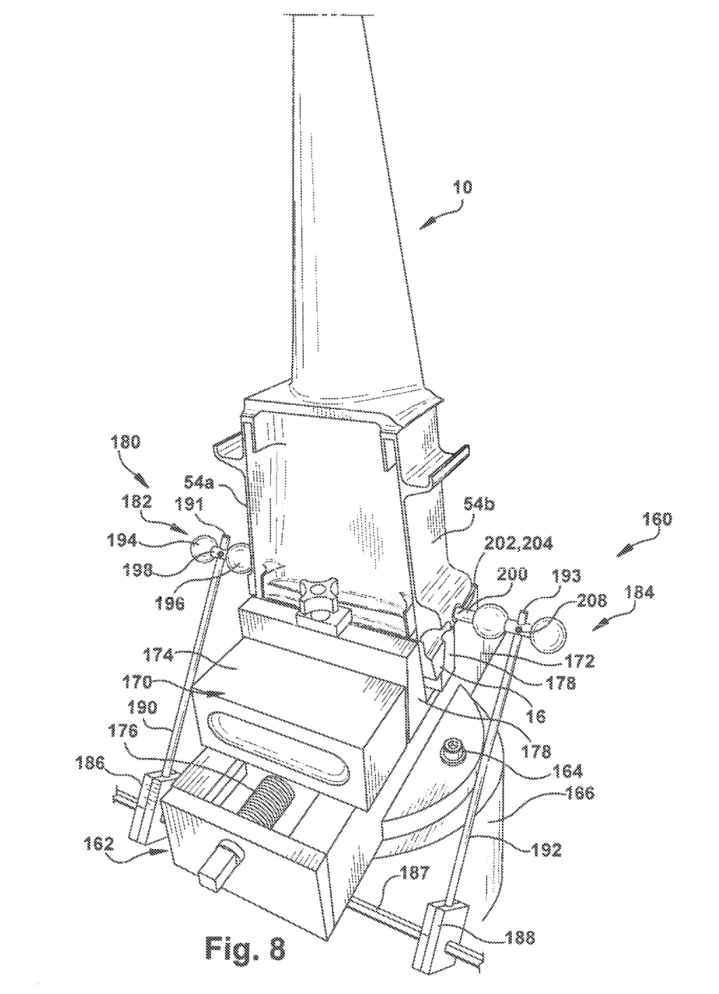

FIG. 8 illustrates an alternate universal fixture assembly 160 and an alternate position indicator assembly 180 with which the inspection method of the present invention may be practiced. The illustrated universal fixture assembly 160 comprises a single load bearing support member 162 and a mounting post 166 on which the load bearing support member is mounted. The mounting post 166 may be a relatively thick cylindrical post of steel or other material capable of carrying or supporting the weight of the turbine blade 10. The material of which the mounting post 166 is made and the thickness of the mounting post are determined such that the load bearing support member 162 is substantially immovable during or while the turbine blade 10 is being inspected. Threaded openings or bores (not shown) are formed in the mounting post 166 to receive threaded fasteners 164 with enlarged heads, such as bolts, inserted into each hole or passage (not shown) in the load bearing support member 162 to hold or maintain the load bearing support member in place or in position on the mounting post.

The load bearing support member 162 includes a vise or clamp assembly 170, which includes a fixed jaw 172, a movable jaw 174, and a screw mechanism 176 to move the movable jaw toward the fixed jaw to clamp the root end portion 16 of the turbine blade 10. Two part specific supports 178 are inserted between the fixed and moveable jaws 172 and 174 of the vise or clamp assembly 170 and the root end portion 16 of the turbine blade 10 to ensure that the root end portion is closely fitted within and held by the vise or clamp assembly between the fixed jaw 172 and the movable jaw 174. The part specific supports 178 may be formed or made from metal or plastic or any other material that will be strong and rigid enough to be engaged by the fixed jaw 172 and the movable jaw 174 substantially without permitting the turbine blade 10 to move. The vise or clamp assembly 170, in turn, is strong and rigid enough to support the weight of the turbine blade 10 substantially without deflecting or moving during inspection of the turbine blade.

The position indicator assembly 180 includes two non-load bearing position indicators 182 and 184, as shown in FIG. 8, which are disposed in contact with the turbine blade 10 in a removable or movable or non-permanent manner such that the non-load bearing position indicators do not support or carry any or substantially any of the weight of the turbine blade 10. The illustrated position indicator assembly 180 comprises the two non-load bearing position indicators 182 and 184, two laterally extending support brackets 186 and 188, and two flexible and resilient spring members or mounting rods 190 and 192. As used in this application, “flexible” means that a material, such as the material of which the mounting rods 190 and 192 are made, is capable of being flexed, which is to say capable of being turned, bowed, or twisted without breaking. As used in this application, “resilient” means that a material, such as the material of which the mounting rods 190 and 192 are formed, is capable of returning freely to a previous position, shape or condition, which is to say capable of recovering its size and shape after deformation.

The non-load bearing position indicator 182 is mounted on or carried by the mounting rod 190. The mounting rod 190, in turn, is mounted on or carried by the support bracket 186. The mounting rod 190, as shown, extends upward and at an angle from the support bracket 186, which is supported by the mounting post 166 via a laterally extending support rod 187. The non-load bearing position indicator 182 is disposed or positioned at or closely adjacent to the upper end 191 of the mounting rod 190. Similarly, the non-load bearing position indicator 184 is mounted on or carried by the mounting rod 192. The mounting rod 192, in turn, is mounted on or carried by the support bracket 188. The mounting rod 192, as shown, extends upward and at an angle from the support bracket 188, which is supported by the mounting post 166 via the laterally extending support rod 187. The non-load bearing position indicator 184 is disposed or positioned at or closely adjacent to the upper end 193 of the mounting rod 192. The non-load bearing position indicator 184 is disposed or positioned at a position that is vertically substantially the same as the position of the non-load bearing position indicator 182 on the mounting rod 190 and that is laterally spaced apart from the position of the non-load bearing position indicator 182 by at least the distance between the first and second side portions 54a and 54b of the root end portion 16 of the turbine blade 10. As can been seen in FIG. 8, one or both of the first and second side portions 54a and 54b may include a projection on which the corresponding raised reference portion 52a and/or 52b is formed.

As can also be seen in FIG. 8, the non-load bearing position indicator 182 is identical to the non-load bearing position indicator 184, and the mounting rod 190 is identical to the mounting rod 192. The non-load bearing position indicator 182 is mounted in an orientation that is a mirror image of the orientation of the non-load bearing position indicator 184. Accordingly, the details of the non-load bearing position indicators 182 and 184 and the interaction between the non-load bearing position indicators and the corresponding mounting rods 190 and 192, respectively, will be partly described initially with reference to the non-load bearing position indicator 182 and its corresponding mounting rod 190 and subsequently described with reference to the non-load bearing position indicator 184.

The non-load bearing position indicator 182 comprises a first spherical member 194 with an outer spherical surface and a second spherical member 196 with an outer spherical surface. The first and second spherical members 194 and 196, and their respective outer spherical surfaces, are identical in their outer dimensions. Like the spherical members 120 and 122 of the non-load bearing position indicators 102 and 104, each of the spherical members 194 and 196 and its respective outer spherical surface is defined with respect to a center point. Specifically, the center point of each of the spherical members 194 and 196 is the central point from which all points on the outer surface of the spherical member are equidistant or at a fixed radius. A shaft 198 extends between the spherical members 194 and 196 and causes the spherical members to be spaced apart fern one another. The first and second spherical members 194 and 196 and the shaft 198 may be formed in one piece or may be formed separately and subsequently permanently joined or fixed together. The distance from the center of the first spherical member 194 along the shaft 198 to the center of the second spherical member 196 is predetermined and precisely measured.

A hollow stub shaft (see corresponding hollow stub shaft 200 of non-load bearing position indicator 184) projects away from the second spherical member 196 at a location diametrically opposite a point at which the spherical member 196 is joined to the shaft 198. The hollow stub shaft, like the hollow stub shaft 200, receives one end of a cone locator, which is substantially identical to cone locator 202 and which includes a short solid shaft like solid shaft 204 and a hemispherical tip (not shown). The solid shaft is received in the open end of the hollow stub shaft, and the hemi-spherical tip projects from the hollow stub shaft. When the cone locator is fully seated in the hollow stub shaft and thus cannot move farther into the hollow stub shaft, the cone locator is fixed in place in the hollow stub shaft. The distance from the center of the first spherical member 194 along the shaft 198 and the stub shaft to the center of the hemi-spherical tip, which is the center of a sphere that includes the outer surface of the hemispherical tip, is thereby predetermined and is precisely measured. The center of the hemi-spherical tip is the central point from which all points on the surface of the hemispherical tip are equidistant.

Formed in the shaft 198 are two intersecting bores or passages (not shown) that extend through the shaft at right angles or perpendicular to one another. One of the intersecting bores receives an end portion of the mounting rod 190, which is adjacent the upper end 191 of the mounting rod. The other of the intersecting bores has a threaded inner surface and receives a set screw (see the set screw 208 for the non-load bearing position indicator 184). The set screw can be screwed into the bore so as to be tightened against the end portion of the mounting rod 190 to hold the non-load bearing position indicator 182 in place along the length of the mounting rod.

When the non-load bearing position indicator 182 is fully assembled and mounted on the mounting rod 190, the non-load bearing position indicator and the end portion of the mounting rod on which the non-load bearing position indicator is mounted can move laterally relative to the support bracket 186, which receives the opposite end portion of the mounting rod. This movement is possible due to the flexible nature of the mounting rod 190. In addition, the resilient nature of the mounting rod 190 causes the mounting rod to push or bias the non-load bearing position indicator 182 and, more specifically, the hemi-spherical tip of the non-load bearing position indicator to the right, as viewed in FIG. 8.

By mounting the support bracket 186 in a first position and mounting the support bracket 188 in a second position spaced apart from the first position, and further by mounting the non-load bearing position indicators 182 and 184 such that their respective hemi-spherical tips are presented toward one another, the non-load bearing position indicators 182 and 184 will be arranged, located or positioned to contact the first conical recess 56a and the second conical recess 56b, respectively, of the exterior surface 50 of the turbine blade 10, as shown in FIG. 8. As will be appreciated, the hemi-spherical tips of the non-load bearing position indicators 182 and 184 will be positioned within the first and second conical recesses 56a and 56b.

After the turbine blade 10 has been supported on the load bearing support member 162 and after the non-load bearing position indicators 182 and 184 have been positioned in contact with the first and second conical recesses 56a and 56b of the turbine blade 10, the next step in the inspection method in accordance with the present invention is to scan the non-load bearing position indicators with a coordinate measuring device such that either one or both of the first and second spherical members 194 and 196 is detected by the coordinate measuring device and such that coordinates of either one or both of the first and second spherical members are determined. This step in the process can be carried out in the same manner illustrated schematically in FIG. 6. Thereafter, all subsequent calculations and determinations are carried out in the same manner as with the position indicator assembly 100 of FIGS. 3-7.

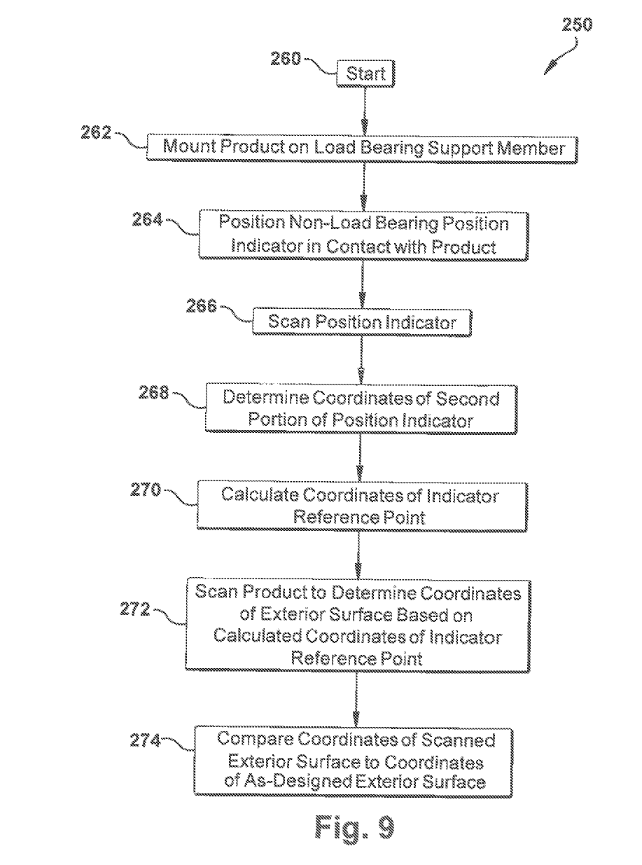

FIG. 9 is a flow chart detailing a process or method 250 of inspecting a product, such as a turbine blade 10, as shown in FIGS. 1 and 2. The method 250 starts at block 260. The method 250 then proceeds to step 262, in which a product, such as the turbine blade 10, is removably mounted on a load bearing support member, for example, the load bearing support members 62 and 64, such that substantially all of the weight of the product is carried by the load bearing support member.

At step 264, a non-load bearing position indicator, such as the non-load bearing position indicator 102, is positioned in contact with the product such that the non-load bearing position indicator does not support substantially any of the weight of the product. The non-load bearing position indicator includes (i) a first portion with an indicator reference surface that contacts a product reference surface on the product and (ii) at least one second portion detectable by a coordinate measuring device. The indicator reference surface is defined with respect to an indicator reference point. The non-load bearing position indicator is configured end dimensioned such that a distance between the indicator reference point and the at least one second portion is predetermined.

The method 250 proceeds to step 266 in which the position indicator is scanned with the coordinate measuring device when the indicator reference surface is in contact with the product reference surface such that the at least one second portion of the non-contact load bearing position indicator is detected. The method 250 next proceeds to step 268, in which coordinates in space of the at least one second portion are determined.

The method 250 thereafter proceeds to step 270, in which coordinates in space of the indicator reference point are calculated based on the determined coordinates of the least one second portion and the predetermined distance between the indicator reference point and the at least one second portion. After step 270, the next step 272 of the method 250 is to scan the product with the coordinate measuring device when the indicator reference surface is in contact with the product reference surface such that coordinates of at least a portion of the exterior surface of the product are determined based on the calculated coordinates of the indicator reference point. Lastly, the method 250 proceeds to step 274, in which (i) the coordinates of said at feast a portion of the exterior surface of the scanned product as determined based on the calculated coordinates of the indicator reference point are compered to (ii) coordinates of a corresponding portion of an ideal exterior surface of an ideal product with an ideal product reference surface.

As described above, the method of the present invention generally involves detecting the outer surfaces of two spherical members, determining the coordinates in space of the centers of the two spherical members, and calculating the coordinates in space of the center of a hemi-spherical tip based on the azimuth or direction of an axis extending through the centers of both spherical members and also on a known or predetermined distance from the center of one of the spherical members to the center of the hemi-spherical tip. Nonetheless, it would be possible to calculate the coordinates in space of the center of a hemi-spherical tip without detecting the outer surfaces of both spherical members. For example, it would be possible to detect the outer surfaces of only a single spherical member and also to detect the outer surface of a shaft, such as the shaft 198. The detected shaft could then provide the azimuth or direction of an axis extending through the center of the detected spherical member and the center of the hemispherical tip, while center of the detected spherical member would provide the starting point from which to measure the known or predetermined distance to the center of the hemi-spherical tip.

From the above description of the invention, those skied in the art will perceive improvements, changes and modifications. Such improvements, changes, and/or modifications within the skill of the art are intended to be covered by the appended claims.

Having described the invention, the following is claimed:

1. A method of inspecting a product, the product having a weight, a longitudinal central axis, and an exterior surface, said method comprising the steps of:
(a) removably mounting the product on at least one load bearing supped member such that substantially all of the weight of the product is supported by the at least one load bearing support member;
(b) positioning at least one non-load bearing position indicator in contact with the product such that the at least one non-load hearing position indicator does not support substantially any of the weight of the product the at least one non-load bearing position indicator including (i) a first portion with a first indicator reference surface that contacts a first product reference surface on the product and (ii) at least one second portion detectable by a coordinate measuring device, the first indicator reference surface being defined with respect to a first indicator reference point, the at least one non-load bearing position indicator being configured and dimensioned such that a distance between the first indicator reference point and the at least one second portion is predetermined;
(c) scanning the at least one non-load bearing position indicator with the coordinate measuring device when the first indicator reference surface is in contact with the first product reference surface such that the at least one second portion of the at least one non-load bearing position indicator is detected and such that coordinates of the at least one second portion are determined;
(d) calculating coordinates of the first indicator reference point based on the determined coordinates of the at least one second portion and the predetermined distance between the first indicator reference point and the at least one second portion;
(e) scanning the product with the coordinate measuring device when the first indicator reference surface is in contact with the first product reference surface such that coordinates of at least a portion of the exterior surface of the product are determined based on the calculated coordinates of the first indicator reference point; and
(f) comparing (i) the coordinates of said at least a portion of the exterior surface of the scanned product as determined based on the calculated coordinates of the first indicator reference point relative to (ii) coordinates of a corresponding portion of an ideal exterior surface of an ideal product with an ideal first product reference surface.

2. The method of claim 1 further including the step of calculating coordinates of the longitudinal central axis of the product based on the calculated coordinates of the first indicator reference point, the coordinates of said at least a portion of the exterior surface of the product being determined based on the calculated coordinates of the longitudinal central axis of the product.

3. The method of claim 1 wherein the at least one non-load bearing position indicator includes two laterally spaced apart second portions, one of said two second portions comprising a first spherical member with a first outer spherical surface, the other of said two second portions comprising a second spherical member with a second outer spherical surface, the at least one non-load bearing position indicator also including a member with an outer hemi-spherical surface that is laterally spaced apart from both the first spherical member and the second spherical member, the outer hemispherical surface being the first indicator reference surface.

4. The method of claim 3 wherein the first outer spherical surface is defined with respect to a first center point, the second outer spherical surface being defined with respect to a second center point, the outer hemi-spherical surface being defined with respect to a third center point, the first, second, and third center points being aligned in a straight line defining a first axis, the third center point being the first indicator reference point.

5. The method of claim 4 wherein the first, second, and third center points are spaced apart from one another along the first axis, a distance from the first center point along the first axis to the second center point being predetermined, a distance from the second center point along the first axis to the third center point also being predetermined.

6. The method of claim 5 wherein the step of scanning the position indicator with the coordinate measuring device comprises detecting at least one of the first and second spherical members and determining coordinates of said at least one of the first and second spherical members.

7. The method of claim 6 wherein the step of calculating coordinates of the first indicator reference point comprises calculating coordinates of the third center point based on the determined coordinates of said at least one of the first and second spherical members and the predetermined distance between the third center point and one or both of the first and second center points.

8. The method of claim 1 wherein the at least one non-bearing position indicator comprises a first non-load bearing position indicator and a second non-load bearing position indicator, the first non-load bearing position indicator comprising
(i) a first spherical member with a first outer spherical surface,
(ii) a second spherical member with a second outer spherical surface, the second spherical member being laterally spaced apart from the first spherical member, and
(iii) a member with a first outer hemi-spherical surface that is laterally spaced apart from the first spherical member and from the second spherical member, the first outer hemi-spherical surface being the first indicator reference surface,
the second non-load bearing position indicator comprising
(i) a third spherical member with a third outer spherical surface,
(ii) a fourth spherical member with e fourth outer spherical surface, the fourth spherical member being laterally spaced apart from the third spherical member, and
(iii) a member with a second outer hemi-spherical surface that is laterally spaced apart from the third spherical member and from the fourth spherical member, the second outer hemi-spherical surface being a second indicator reference surface that contacts a second product reference surface on the product, the second indicator reference surface being defined with respect to a second indicator reference point.

9. The method of claim 8 wherein the step of positioning at least one non-load bearing position indicator in contact with the product comprises positioning the first indicator reference surface in contact with the first product reference surface and positioning the second indicator reference surface in contact with the second product reference surface.

10. The method of claim 9 wherein the step of scanning the at least one non-load bearing position indicator with the coordinate measuring device when the first indicator reference surface is in contact with the first product reference surface comprises scanning the first non-load bearing position indicator with the coordinate measuring device when the first indicator reference surface is in contact with the first product reference surface such that at least one of the first spherical member and the second spherical member is detected and such that coordinates of the at least one of the first spherical member and the second spherical member are determined, the step of calculating coordinates of the first indicator reference point comprises calculating coordinates of the first indicator reference point based on the determined coordinates of the at least one of the first spherical member and the second spherical member and the predetermined distance between the first indicator reference point and the at least one of the first spherical member and the second spherical member, the method further comprising the stops of:
(g) scanning the second non-load bearing position indicator with the coordinate measuring device when the second indicator reference surface is in contact with the second product reference surface such that at least one of the third spherical member and the fourth spherical member is detected and such that coordinates of the at least one of the third spherical member and the fourth spherical member are determined;
(h) calculating coordinates of the second indicator reference point based on the determined coordinates of the at least one of the third spherical member and the fourth spherical member and the predetermined distance between the second indicator reference point and the at least one of the third spherical member and the fourth spherical member; and
(i) calculating the coordinates of an axis passing in a straight line through the first indicator reference point and through the second indicator reference point.

11. The method of claim 10 wherein the step of scanning the product with the coordinate measuring device when the first indicator reference surface is in contact with the first product reference surface comprises scanning the product with the coordinate measuring device when the first indicator reference surface is in contact with the first product reference surface and the second indicator reference surface is in contact with the second product reference surface such that coordinates of at least a portion of the exterior surface of the product are determined based on the calculated coordinates of the axis passing in a straight line through the first indicator reference point and through the second indicator reference point.

12. The method of claim 11 further comprising the step of:
(j) calculating the coordinates of a product center line based on the coordinates of the axis passing in a straight line through the first indicator reference point and through the second indicator reference point
the step of scanning the product with the coordinate measuring device when the first indicator reference surface is in contact with the first product reference surface comprising scanning the product with the coordinate measuring device when the first indicator reference surface is in contact with the first product reference surface and the second indicator reference surface is in contact with the second product reference surface such that coordinates of at least a portion of the exterior surface of the product are determined based on the calculated coordinates of the product centerline.

13. The method of claim 12 wherein the step of positioning at least one non-load bearing position indicator in contact with the product comprises resiliency biasing the first non-load bearing position indicator toward the product when the product is supported by the at least one load bearing support member and resiliency biasing the second non-load bearing position indicator toward the product when the product is supported by the at least one load bearing support member.

14. The method of claim 1 wherein the at least one non-bearing position indicator comprises a first non-load bearing position indicator and a second non-load bearing position indicator, the first non-load bearing position indicator comprising a first spherical member with a first outer spherical surface, the first non-load bearing position indicator also comprising a member with a first outer hemi-spherical surface that is laterally spaced apart from the first spherical member, the second non-load bearing position indicator comprising a second spherical member with a second outer spherical surface, the second non-load bearing position indicator also including a member with a second outer hemi-spherical surface that is laterally spaced apart from the second spherical member, the first outer hemi-spherical surface being the first indicator reference surface, the second outer hemi-spherical surface being a second indicator reference surface that contacts a second product reference surface on the product.

15. A system for inspecting a product, the product having a weight, a longitudinal central axis, and an exterior surface, said system comprising:
(a) at least one load bearing support member that when supporting the product supports substantially all of the weight of the product;
(b) at least one non-load bearing position indicator that when positioned in contact with the product does not support substantially any of the weight of the product; and
(c) a coordinate measuring device,
the at least one non-load bearing position indicator including (i) a first portion with a first indicator reference surface that contacts a first product reference surface on the product and (ii) two laterally spaced apart second portions detectable by the coordinate measuring device, the first indicator reference surface being defined with respect to a first indicator reference point, the at least one non-load bearing position indicator being configured and dimensioned such that a distance between the first indicator reference point and at least one of the two second portions is predetermined,
one of said two second portions comprising a first spherical member with a first outer spherical surface, the other of said two second portions comprising a second spherical member with a second outer spherical surface, the at least one non-load bearing position indicator also including a member with an outer hemi-spherical surface that is laterally spaced apart from both the first spherical member and the second spherical member, the outer hemi-spherical surface being the first indicator reference surface.

16. The system of claim 15 wherein the first outer spherical surface is defined with respect to a first center point, the second cuter spherical surface being defined with respect to a second center point the outer hemi-spherical surface being defined with respect to a third center point, the first, second, and third center points being aligned in a straight line defining a first axis, the third center point being the first indicator reference point.

17. The system of claim 16 wherein the first, second, and third center points are spaced apart fern one another along the first axis, the distance from the first center point along the first axis to the second center point being predetermined, the distance from the second center point along the first axis to the third center point also being predetermined.

18. The system of claim 15 wherein the at least one non-load bearing position indicator comprises a first non-load bearing position indicator and a second non-load bearing position indicator, the first non-load bearing position indicator comprising
(i) a first spherical member with a first outer spherical surface detectable by the coordinate measuring device,
(ii) a second spherical member with a second outer spherical surface detectable by the coordinate measuring device, the second spherical member being laterally spaced apart from the first spherical member, and
(iii) a member with a first outer hemi-spherical surface that is laterally spaced apart from the first spherical member and from the second spherical member,
the first outer spherical surface being defined with respect to a first center point, the second outer spherical surface being defined with respect to a second center point, the outer hemi-spherical surface being defined with respect to a third center point, the first, second, and third center points being aligned in a straight line defining a first axis, the first, second, and third center points being spaced apart from one another along the first axis, a distance from the first center point along the first axis to the second center point being predetermined, a distance from the second center point along the first axis to the third center point also being predetermined, the first outer hemi-spherical surface being the first indicator reference surface,
the second non-load bearing position indicator comprising
(i) a third spherical member with a third outer spherical surface detectable by the coordinate measuring device,
(ii) a fourth spherical member with a fourth outer spherical surface detectable by the coordinate measuring device, the fourth spherical member being laterally spaced apart fern the third spherical member, and
(iii) a member with a second outer hemi-spherical surface that is laterally spaced apart from the third spherical member and from the fourth spherical member,
the third outer spherical surface being defined with respect to a fourth center point, the fourth outer spherical surface being defined with respect to a fifth center point, the outer hemispherical surface being defined with respect to a sixth center point, the fourth, fifth, and sixth center points being aligned in a straight line defining a second axis, the fourth, fifth, and sixth center points being spaced apart from one another along the second axis, the distance from the fourth center point along the second axis to the filth center point being predetermined, the distance from the fifth center point along the second axis to the sixth center point also being predetermined, the second outer hemi-spherical surface being a second indicator reference surface that contacts a second product reference surface on the product.

19. The system of claim 18 further comprising a first spring member and a second spring member, the first spring member resiliency biasing the first non-load bearing position indicator toward the product when the first indicator reference surface contacts the first product reference surface, the second spring member resiliency biasing the second non-load bearing position indicator toward the product when the second indicator reference surface contacts a second product reference surface.

20. A non-load bearing position indicator for use in inspecting a product the product having a weight a longitudinal central axis, and an exterior surface, said non-load bearing position indicator comprising:
(i) a first spherical member with a first outer spherical surface detectable by a coordinate measuring device,
(ii) a second spherical member with a second outer spherical surface detectable by the coordinate measuring device, the second spherical member being laterally spaced apart from the first spherical member, and
(iii) a member with a first outer hemi-spherical surface that is laterally spaced apart from the first spherical member and from the second spherical member,
the first outer spherical surface being defined with respect to a first center point, the second outer spherical surface being defined with respect to a second center point, the first outer hemi-spherical surface being defined with respect to a third center point, the first, second, and third center points being aligned in a straight line defining a first axis, the first, second, and third center points also being spaced apart from one another along the first axis, a distance from the first center point along the first axis to the second center point being predetermined, a distance from the second center point along the first axis to the third center point also being predetermined, the first outer hemi-spherical surface being an indicator reference surface that contacts a product reference surface on the product, the non-load bearing position indicator when the indicator reference surface is positioned in contact with the product reference surface does not support substantially any of the weight of the product.
